(19) United States
(12) Patent Application Publication
(10) Pub. No.: US 2006/0126480 A1
(43) Pub. Date: Jun. 15, 2006

(54) Compensated optical storage medium

(76) Inventors: Lars Lindvold, Kokkedal (DK); Jesper Tidemann, Losning (DK)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/520,898

(22) PCT Filed: Jul. 11, 2003
(86) PCT No.: PCT/DK03/00488

§ 371 Date: Sep. 30, 2005

Related U.S. Application Data
(60) Provisional application No. 60/394,875, filed on Jul. 11, 2002.

(30) Foreign Application Priority Data
Jul. 11, 2002 (DK) PA 2002 01090
May 20, 2003 (DK) PA 2003 00765

(51) Int. Cl. G11B 7/24

(52) U.S. Cl. 369/275.1; 369/272.1

(57) ABSTRACT

A optical storage medium is provided, comprising a main substrate, an information surface being associated with the main substrate, and at least one compensating layer. The compensating layer may change a phase and/or amplitude of a propagating electromagnetic wavefront according to a first optical transfer function so that the optical storage medium may be read or recorded by a detector/emitter being pre-set to read or record information at an information surface through a medium changing the phase and/or amplitude of a propagating wavefront according to a predetermined optical transfer function being different from the first optical transfer function. The compensating layer may optically reduce a spot size of a light beam incident on the information surface, and/or compensate for aberrations caused by a first distance being different from a predetermined distance. The substrate may be non-transparent and/or thinner than standard substrates. Methods of making such media are also provided.

### FIELD OF THE INVENTION

The present invention relates to a compensated optical storage medium so as to allow the medium to be played in any play-back device, more particularly, the optical storage medium comprises a main substrate, an information surface being associated with the main substrate, and at least one compensating layer positioned between the information surface and an outer surface of the medium. Furthermore, the invention relates to a method for making said optical storage medium.

### BACKGROUND OF THE INVENTION

Generally optical storage media are known. Examples of optical storage media are Compact Discs (CD) and Digital Versatile Discs (DVD). The media comprises a main substrate on which a nano-structure representing information in digital form is provided on a first surface of the disc. The digital information is read from a second opposite side of the disc and thus the main substrate is transparent. The transparent material is a plastic material often polycarbonate.

In order to improve the reflection of a laser beam having a predetermined wavelength transmitted through the main substrate from the second side to the first side comprising the nano-structure, the nano-structure is provided with a reflective layer. It is critical for the media that the main substrate is transparent at least in the wavelength range comprising the predetermined wavelength, as a laser beam can not be transmitted through a non-transparent substrate. On top of the reflective layer is often applied a lacquer. On the lacquer is often applied a colour print containing information about the media, such as the name of an artist and titles of e.g. the songs of the record.

As the main substrate is made of a transparent material any kind of light, e.g. day light or a laser beam, is transmitted through the substrate. A known property of plastic substrates is that the substrate deteriorate when exposed to UV light and thus over time the quality of the disc decrease resulting in a disc which can not be read by e.g. a compact disc player or a CD-ROM drive. As optical storage media are also used for storing information, it is desired that the disc is readable over time especially for archives comprising information which must be accessible for decades.

Due to the deteriorating nature of known optical storage media institutions storing information such as libraries, national archives etc. are reluctant to use the optical storage media. Thus the information storing institutions fail to obtain the advantages of the space saving media.

Another area of interest is to differentiate the optical storage media from other producers or users of the optical storage media or from any counterfeit copies being made by using a non-standard substrate material. The use of another substrate material than standard substrate materials may convince consumers of the authenticity of the product and thus avoid or reduce the sale of counterfeit copies.

Furthermore, in order to increase primarily the reading speed in current optical storage technology, such as in CD-ROM drives, etc., rotational speed of disc formed optical storage media is increased. However, present optical storage media are typically formed in a brittle polymeric material so that the disc, such as a CD-ROM tends to shatter when exposed to the induced centrifugal forces at these increased speeds.

### DESCRIPTION OF THE INVENTION

It is the object of the present invention to provide an optical storage medium which overcomes the above mentioned disadvantages.

It is an object of the present invention to provide an optical storage medium capable of withstanding high centrifugal forces stemming from correspondingly high rotation speeds of the medium.

It is a further object of the present invention to provide an optical storage medium which may be read by a standard optical playback device, such as any Compact Disc player, Digital Versatile Disc player, any PC or Mac comprising an optical disk drive, such as a DVD or CD-ROM drive, any game platform, such as Playstation®, Xbox®, Nintendo GameCube, any MP3 player, any MPEG player, etc.

It is a further object of the present invention to provide an optical storage medium which may be recorded in a standard optical recording device.

It is a further object of the present invention to provide an optical storage medium which comprises compensating means, so that substantially no distortion of the playback signal is observed by the playback device.

In a first aspect of the invention the above and other objects are fulfilled by an optical storage medium comprising:
a main substrate,
an information surface being associated with the main substrate, and
at least one compensating layer.

The optical storage medium may be a compensated optical storage medium.

It is an advantage that the compensating layer is positioned in, in connection with or adjacent to the optical storage medium so as to for example allow for play-back of the optical storage medium in any play-back device without needing to modify the optical system in the play-back device to suit the specific optical storage medium.

In a preferred embodiment, the compensating layer is positioned between the information surface and an outer surface of the medium.

The compensating layer may be changing a phase and/or amplitude of a propagating electromagnetic wave front according to a first optical transfer function so as to adapt the optical storage medium to be read or recorded by a detector/emitter being pre-set to read or record information at an information surface through a medium changing the phase and/or amplitude of a propagating wave front according to a predetermined optical transfer function, wherein the first optical transfer function is different from the predetermined optical transfer function.

The optical transfer function denotes modulation and spatial phase shift of the image of a sinusoidal test pattern with the spatial frequency of the test pattern as the independent variable.

Typically, the optical system in a play-back device is pre-set or pre-compensated to support reading or recording of a specific optical storage medium having well-defined optical properties and a predetermined optical transfer function.

The at least one information surface may be positioned at at least a first distance from an outer surface of the medium. The first distance may correspond to the thickness of the compensated layer or it may be the optical distance or the optical path length for the electromagnetic wave. In this embodiment, the compensating layer may be positioned between the outer surface and the information surface for compensating for the at least first distance being different from a predetermined distance by optically altering a spot size of an incoming light beam on the information surface.

The predetermined distance may be a distance to the information surface being pre-set in the optical system of a play-back device. The predetermined distance may be the optical distance or optical path length from the outer surface of the medium to the information surface or it may be the physical distance normal to the surface of the optical storage medium, and the optical system may then be pre-compensated so as to facilitate reading or recording of the information surface, being positioned in a predetermined distance from the outer surface and through a specific material.

In another aspect of the invention, the above and other objects are fulfilled by an optical storage medium comprising:
a main substrate, and
at least one information surface positioned at at least a first distance from an outer surface of the medium,
   wherein the information surface comprises information in the form of a deep surface relief, having a profile being larger than a predetermined profile whereby correction of aberrations caused by the at least first distance being different from a predetermined distance is obtained.

The predetermined profile be the profile of a standard optical storage medium to be played back in a standard play-back device. The predetermined profile may for example have a first pit-to-valley height and the deep surface relief may have a second pit to valley height being up to 50 times larger than the first pit-to-valley height.

Furthermore, at least one compensating layer as described above may be provided in addition to the deep surface relief.

Alternatively or additionally, the at least one information surface may be positioned at at least a first distance from an outer surface of the medium, and the compensating layer may be positioned between the outer surface and the information surface for compensating for aberrations caused by the at least first distance being different form a predetermined distance.

Alternatively or additionally, the cone angle of an incoming light beam may be reduced in the compensating layer, so that the at least one information surface may be positioned at a first distance from an outer surface of the medium, and the compensating layer may be positioned between the outer surface and the information surface to compensate for the first distance being different from a predetermined distance by optically reducing a cone angle of an incoming/incident light beam.

The predetermined distance may be a distance to the information surface being pre-set in the optical system of a play-back device. The predetermined distance may be the optical distance or optical path length from the outer surface of the medium to the information surface or it may be a physical distance, for example the distance normal to the surface of the optical storage medium, and the optical system may then be pre-compensated so as to facilitate reading or recording of the information surface, being positioned in a predetermined distance from the outer surface and through a specific material.

In a standard CD or DVD, the distance between an outer surface of the CD or DVD and the information layer is set to be 1,2 mm or 0,6 mm of polycarbonate by the providers of the CD and DVD players. Thus, the optical system in the CD and DVD players is adjusted so as to read information on an information surface, comprising for example music or picture information through this specific layer. The optical system of the CD and DVD players is thus adjusted to suit the optical properties of a 1,2 or 0,6 mm thick layer of polycarbonate having optical grade quality or a polymer with similar optical properties, such as a polymer having low stress induced birefringence, such as Topas®) manufactured by Hoechst.

In order to obtain a more reliable optical storage medium which do not deteriorate over time, e.g. upon exposure to UV light, it is an advantage to use less sensitive materials for optical storage.

However, when using a material other than polycarbonate, it is not always preferred to have a thickness of for example 1,2 mm, such as 1,2 mm+/−0,1 mm, such as 1,2 mm+0,3/−0,1.

So according to another aspect of the present invention the use of an information storage medium having a thickness of less than 1,1 mm in a standard optical playback device is provided.

In a preferred embodiment, metals or alloys are used as a substrate material, however also glass, polymers, such as elastomers, paper, cardboard, wood, veneer, plywood, fiber materials, bio-materials, stones, ceramics, concrete or any combinations thereof may be used as main substrate.

It is an advantage of using a substrate comprising at least one metallic material that the substrate is non-transparent and further that a metal substrate will not deteriorate due to exposure to UV light.

When using e.g. a glass material, it is preferred that the glass comprises a colour, e.g. so that the glass has a coloured appearance. The glass may for example comprise a solid colour, e.g. black, so that it is non-transparent. Additionally, a substrate comprising polymers or elastomers may comprise a colour so that UV light will not enter and deteriorate the plastic material.

In one embodiment of the invention, the main substrate is made of cardboard and thus the optical storage medium may be provided in e.g. an A4-shaped piece of cardboard for example by embossing the storage medium. The storage medium may for example be embossed such that a weakened line separates the optical storage medium from the rest of the cardboard. In another embodiment the cardboard is covered with structure supporting layer e.g. a lacquer on which the information surface is provided. In an embodiment the medium may be made of cardboard in such a way that the medium may be comprised in e.g. a box made of card board. A weakening line may make it possible to press the medium out of the surface of the box. Thus the medium may be part of a package comprising e.g. cereals and a commercial for another product may be embedded in the surface of the box comprising the cereals.

The metal and/or alloys may be any metal or alloy, such as a metal or alloy comprising any materials selected from the group consisting of iron, steel, aluminium, magnesium, titanium, copper, nickel, zinc, cadmium, tin, lead, chrome, tungsten, silver, gold, platinum, stainless steel, tinplate and molybdenum.

The polymers to be used as substrate material may be any polymers, such as any thermoplastic, such as an amorphous thermoplastic or a crystalline thermoplastic, or any thermosetting plastics, such as any polymers having high stress induced birefringence, such as any polymers being optically anisotropic, and the substrate may alternatively or additionally comprise at least one material selected from the group consisting of polyester, such as PET or APET, acrylics, such as polyethylene naphathalate (PEN) and polymethylmethacrylate (PMMA), polystyrene, acrylbutatinstyrene, polypropylene and polyethylene. Furthermore, any combination of these materials may be used.

The main substrate is preferably substantially non-transparent and thus substantially no light is transmitted through the main substrate. The substrate may be a bearing substrate, so that the desired stiffness of the optical storage medium is not provided if the said substrate is not present. Thus, the optical storage medium may collapse or not comprise a needed stability if the substrate is not bearing. Alternatively, the substrate may be a supporting for supporting the film layer(s) and compensating layer(s) without being bearing.

According to the material properties of the substrate material, it may be preferred to have a thickness of less than 1,2 mm, such as of less than 1,1 mm, such as less than 1,09 mm, such as less than 1 mm, such as less than 0,8 mm, such as less than 0,6 mm, such as less than 0,4 mm, such as less than 0,2 mm.

The thickness of the substrate material may likewise be between 1,2 mm and 0,2 mm, such as between 1,1 mm and 0,15 mm, such as between 1,09 and 0,2 mm, such as between 1,0 mm and 0,3 mm, such as between 0,8 mm and 0,4 mm, such as between 0,7 and 0,5 mm, such as between 0,6 mm and 1,2 mm, such as between 600 μm and 1200 μm, or a thickness above 1,2 mm, such as a thickness above 1200 μm, such as a thickness above 1,3 mm, such as a thickness above 1,5 mm, such as a thickness between 1,55 mm and 3 mm.

The information surface is a surface from which information may be obtained by reading the surface by an optical light source emitting an electromagnetic wave towards the surface. The information surface may comprise a first nano-structure representing information in digital form.

The optical storage medium may comprise one information surface e.g. such as a medium corresponding to a Compact Disc or a CD-ROM, but the medium may also comprise a plurality of information surfaces such as two, three, four, five, six, seven, eight, nine, or even ten or more information surfaces. The information surfaces may be provided side by side or on top of each other e.g. separated by layers such that the disc may comprise a multi-layer structure of information surfaces, e.g. such that the disc may be used as e.g. a DVD or a DVD-ROM. The information surfaces may extend in the same direction and/or be provided in the same plane, but could also be provided in planes being transverse to each other, e.g. the angel between at least a part of two planes may be 5 degrees, or 10 degrees, or 15 degrees or 20 degrees, or 30 degrees, or 40 degrees.

Each information surface may comprise one nano-structure but could also comprise a plurality of nano-structures dividing the information surface in to a plurality of zones. The information surface may comprise two nano-structures, or three nano-structures, or four nano-structures, or five nano-structures, or six nano-structures, or seven nano-structures or eight nano-structures, or nine nano-structures. Some nano-structures may comprise information in digital form, while others are adapted to support definition of information in digital form. Some of the nano-structures may be changed once by application of an electromagnetic field and/or by an electromagnetic wave e.g. a laser beam while others may be changed a plurality of times.

The information surface may be formed in the main substrate or it may be formed in a film layer deposited on the main substrate. Alternatively or additionally, the information surface may be formed in an additional substrate, such as in a first, second, third, or fourth substrate connected to the main substrate, for example be adhering at least a part of the additional substrate to at least a part of a surface of the main substrate. The substrates may be bonded by means of gluing, such as UV-gluing, adhering, bonding, lamination, heatsealing, etc. A buffer layer may be provided between the and the film layer and/or any of the additional layers, primarily for improving the adhesion of the film layer and/or any of the additional substrates.

Furthermore, other layers, such as reflective or semi-reflective layers may be provided in between the layers and/or the additional substrates and/or between these layers and the main substrate.

The different information surfaces, for example information surfaces in different substrates, may be read or recorded by the same laser or a different laser. The optical storage medium may, thus, be provided such that the information surfaces may be read by e.g. two, three, four or five lasers.

The buffer layer may for example be an acrylic or an epoxy having a good adhesion to e.g. a metal substrate and also to many materials to be used as film layer. For some materials, such as e.g. plastics or polymers, it may be sufficient to treat the surface to obtain a better adhesion of the film layer, for example by altering the free energy of the surface, such as by giving the surface a Corona treatment. Alternatively, the surface may be given a chemical surface treatment for improving adhesion to the surface.

The film layer may be reflective, or the film layer may be transparent at least in a specific wavelength range and the main substrate, any additional substrates and/or the buffer layer may be reflective. Alternatively, the film layer or any of the substrates may be covered by a reflective layer.

The film layer may be any polymer suitable for holding the information layer, i.e. any surface suitable for having a nano-structure embossed therein, the film layer may be any deposited film of metal, semi-conductor material, polymer, lacquer, etc.

It is preferred to coat the information surface formed either in the film layer or in any of the substrates by a protective layer so as to protect the information surface against dirt and small particles which could deteriorate the performance of the optical storage medium.

Furthermore, the protective layer may serve as protection against corrosion. Primarily, information surfaces not covered by another layer or substrate need to be protected by a protective layer. The protective layer may be coated on top of the reflective layer. Furthermore, the information surface formed either in the film layer or in any of the substrates may be coated by a planarising layer. The protective and planarising layer may be formed by the same layer, e.g. by one layer. By having a planarised surface of the storage medium, the storage medium is less sensitive to dirt and small particles present on the surface of the medium.

The information surface may be read or recorded through at least the main substrate and/or through the compensating layer. In standard CD and DVD players the information surface is read through the main substrate and any additional film layers or substrates. However, when using a compensating layer, the need for reading through 1,2 or 0,6 mm of polycarbonate is eliminated and therefore, the structure of the storage medium may be provided to allow for reading either through at least the main substrate and/or through the compensating layer. Depending on the structure, the read-through material may comprise either the main substrate, any additional substrates and/or film layers, the compensating layer or any combination of these.

In a standard system for reading or recording optical storage media, the optical system for reading or recording is carefully adapted to record or read optical information at an information surface positioned at a distance of 1.2 mm of polycarbonate or an other optical material having similar properties, such as a cyclicolefin copolymer, such as Topas® manufactured by Hoechst, from an outer surface of the media. When using a read-through material having another optical transfer function than the standard materials, or when using a media having a thickness different from a predetermined thickness, the phase and/or amplitude of a propagating electromagnetic wave for reading or recording need to be adjusted or compensated so that they may still be read or recorded in a standard optical system.

In one preferred embodiment, the predetermined optical transfer function corresponds to the optical transfer function in a 1,2 mm thick polycarbonate material for a wave front having a wavelength of 785 nm propagating in the polycarbonate material of optical grade quality. In another preferred embodiment the predetermined optical transfer function corresponds to the optical transfer function for a wave front having a wavelength of 670 nm propagating in a 0.6 mm thick polycarbonate material of optical grade quality.

The main substrate and/or any additional substrates may comprise a number of materials each having different optical properties, and the optical transfer function is then calculated on the basis of the number of materials and their respective optical properties.

Furthermore, when using a read-through material having other optical properties than the standard polycarbonate material, the spot size of an incident light beam on the information surface will not correspond to the spot size of an incident light beam having propagated through the standard polycarbonate material, thus also the focus depth may be changed.

To facilitate reading of the information surface by a standard optical reading/recording system when the optical transfer function and/or the spot size on the information surface is changed, a compensating layer need to be inserted to compensate for the change in optical transfer function and/or spot size.

The compensating layer may compensate for the information layer being positioned at at least a first distance from an outer surface of the storage medium, the at least first distance being different from a predetermined distance.

The compensation may be provided for example by providing an interference filter, such as a bandwidth filter, in the path of the propagating electromagnetic wave to read or record the information of the information surface.

The interference filter(s) may comprise transmission or reflection filters, or a combination of reflection and transmission filters. Furthermore, the interference filters may comprise low pass or high pass filters, or a combination of high pass, low pass, reflection and transmission filters. Hereby, for example filters allowing for passing of more than one specific wavelength may be designed, e.g. to allow for reading or recording of multiple information surfaces by multiple wavelengths.

Preferably, the transmission/reflection characteristic of the filters is selected to be within +/−20 nm of a centre wavelength, such as within +/−15 nm, such as within +/−10 nm, even more preferred within +/−5 nm. Furthermore, asymmetric filters may be preferred, in that asymmetric filters tends to be less sensitive to a phase change of the incident light. Thus, a filter having a few nm asymmetry, such as 2, 3, 4, or 5 nm of asymmetry may be used.

Furthermore, when using high pass and/or low pass filters, they may be selected to have a transmission/reflection characteristic having an edge slope of less than 20 nm, such as less than 15 nm, such as less than 10 nm, preferably such as less than 5 nm.

The compensating layer may comprise at least one dielectric layer. For example such as a dielectric layer comprising multiple layers, for example so that each of the alternating layers has an index of refraction being significant of said layer and preferably so that the alternating layers have high and low refractive indices, respectively. The dielectric multi-layered interference filters may be formed so that the high refractive index material layers and the low refractive index layers are alternately layered with a thickness of ¼ of a predetermined wavelength, λ, preferably being the wavelength of the electromagnetic wave for reading the information surface. Preferably, the indices of refraction of the alternating layers are chosen within a range from approximately 1.2 to approximately 2.5. The dielectric layer may for example comprise at least a first layer having a relatively low index of refraction being within a range from approximately 1.2 to approximately 1.6, and at least a second layer having a relatively high index of refraction being within a range from approximately 2.0 to approximately 2.5. It is, though, envisaged that the optimum thicknesses and/or indices of refraction are dependent on the specific light source to be used for reading and/or recording and of the wavelength of the light emitted from the light source. Furthermore, the thickness of the layers may be tightly controlled according to the wavelength of the light to be incident on the specific dielectric layer, and it is further preferred to manufacture the dielectric layer so that the water content of the dielectric layer is minimized.

It is, thus, to be understood that the dielectric layers are manufactured so as to provide a match between the dielectric layer and the emitted wavelength of the specific light source to be used in a specific system.

The number of layers in such a dielectric layer may depend on the manufacturing process and may be for example more than 20, such as more than 40, such as more than 60, such as more than 80, such as more than 100 layers, such as more than 300 layers, such as more than 500 layers. For example between 20 and 100 layer, between 100 and 300 layers, between 20 and 500 layer, such as between 100 and 400 layers.

The high refractive index material is preferably PbO₂, ZrO₂, TiO₂, ZnS, etc, and the low refractive index material is preferably SiO₂, MgF₂, Al₂O₃, Na₃AlF₆ (cryolite), etc. It should, however, be envisaged that also other dielectric materials may be used to obtain a layer having the desired properties.

By shifting the thickness of each layer and/or by combining several reflective layers having different wavelength bandwidths, the wavelength of the reflected/transmitted light may be carefully selected. An intermediate layer, preferably having a thickness corresponding to the predetermined wavelength may be provided between alternating layers of high refractive index material and low refractive index material so as to provide a dielectric stack.

In a preferred embodiment the multi-layered structure comprises alternating layers of titanium-dioxide (TiO₂) and quartz (SiO₂ or SiOₓ), each having a thickness corresponding to ¼ of a predetermined wavelength (=L). The number of alternating layers of TiO₂ and SiOₓ, may be interconnected via an intermediate layer, such as a SiO layer to form a dielectric stack. Preferably, the thickness of the intermediate layer corresponds to the predetermined wavelength (=4L).

The layers may be evaporated on to the surface by evaporation, such as by electron beam evaporation, by sputtering or preferably by deposition, such as by chemical vapour deposition, such as by low pressure chemical vapour deposition. Alternatively, a film layer may be a separate film or foil adapted to be laminated, glued, bonded or adhered to the substrate or any buffer layer on the substrate by any other means.

Alternatively, the multi layer films may comprise polymers, such as alternating layers of different polymers. Preferably, the alternating polymer layers are manufactured by extruding the polymer materials under heat and pressure and combined into a multi layer web with controlled layer thickness distribution. This web of thick material is then stretched to form a final multi layer film having the desired optical properties. In a preferred embodiment the compensating layer comprises optical birefringent material. Hereby, for example the reflectivity of the compensating layer for p-polarized light may be controlled by controlling the birefringent properties of the birefringent material. For example, the Brewsters angle of the compensating layer may be controlled by controlling the birefringent properties of the birefringent material.

The polymers may comprise alternating layers of polyesters and acrylics, such as polyethylene naphathalate (PEN) and polymethylmethacrylate (PMMA). Acrylics are usually optically isotropic and have a refractive index of about 1.48. Polyesters can range from being optically isotropic to being highly anisotropic and may have a refractive index from 1,5 to 1,75.

The compensating layer may further comprise liquid crystal materials to provide an interference filter, for example comprising Chiral Nematic crystals. The information surface may be provided in the compensating layer, hereby having the compensating layer corresponding to the film layer mentioned above.

Furthermore, to reduce the number of steps required for manufacturing of an optical storage medium the film layer may comprise an interference filter. Furthermore, the information surface may be formed in the interference filter.

It may be an advantage that the interference filters described herein typically are polarisation dependent.

The thickness of the compensating layer may be 0,5 μm-200 μm, such as 0,5 μm-150 μm, 1 μm-100 μm, preferably such as 1 μm-50 μm, 5 μm-40 μm, 8 μm-35 μm, 10 μm-30 μm, 15 μm-25 μm, 20 μm-25 μm.

Alternatively or additionally, optical aberrations, such as chromatic aberrations, spherical aberrations, and/or off-axis aberrations or other phase aberrations may be corrected for by providing a deep surface relief as the information surface. To obtain a correction for the aberrations, the surface profile i.e. grooves, tracks, pits and/or indentations need to be deeper/higher than in a standard optical storage medium, so that the deep surface relief may act as an artificial dielectric surface. For example, the pit depth may be more than 0,5 μm, such as between 0,5 μm-10 μm, such as between 1 μm-5 μm, or the height may be more than 1 μm. However, it is preferred that the pit depth satisfies the condition for obtaining constructive or destructive interference on a detector for proper detection of data, the condition for obtaining constructive or destructive interference being wavelength dependent.

The information surface may make the optical storage medium recognisable for an optical detecting device. An optical detecting device may be a device comprising electromagnetic wave emitting means and means for detecting a reflected light beam. The optical device may thus be a Compact Disc player, a Compact Disc recorder or a DVD-drive or a Laser disc or a DVD-player or a DVD-recorder or a CD-ROM drive or a DVD-ROM drive. The information surface may be recognisable due to information stored on said surface. The information may comprise information about tracks on the medium or could be information about the capacity of the optical storage medium.

The digital information represented in the nano-structure may be audio and/or video and/or data, such as data for a computer, such as data for a computer game application. The digital information may comprise a multi-channel sound such as 5.1 channels e.g. Dolby digital but the information may also comprise Digital Theatre Sound, DTS, and could comprise a combination of sound and picture such that a movie picture may be stored on the optical storage medium. The optical storage medium may comprise computer games e.g. combined with a movie picture. The information may be music or speech or noise or a recording of sound in nature or a recording of any other kind of sound.

The information may be encoded but could also be non-encoded. The information may comprise an encoded part and a part comprising an algorithm for decoding the information. The decoding algorithm may be mpeg 1, such as mpeg 1-layer 3 (mp3), mpeg 4 or any other algorithm for compressing information.

In a preferred embodiment, the optical storage medium is flat and the circumference of the medium may be round such as elliptic or circular. The medium may however also have any polygonal shaped circumference, such as a triangle or a quadrangle or a polygon with five, six, seven, eight, nine or ten edges, or the polygon may have even more edges. The polygonal shaped storage medium may have smooth edges and/or corners e.g. such that the medium has substantially the same shape as a credit card or an access card. The optical storage medium may have the shape of a key-ring or a key for e.g. a door or any other shape.

The optical storage medium may further comprise a second nano-structure supporting definition of the first nano-structure. The definition of said second nano-structure may be required for the optical storage medium to be recognisable for an optical detecting device. The information surface may comprise at least one geometrical structure supporting definition of the first nano-structure. The geometrical structure may be one track but could also be a plurality of tracks. The information surface may comprise a nano-structure comprising a plurality of pits, a pit being a point on the surface where the surface is elevated. The pits may be provided on the information surface so that they extend in the same direction so as to form a geometrical structure.

The geometrical structure may comprise a first zone defining a first nano-structure and/or a second zone defining the second nano-structure. The first nano-structure may be provided with a plurality of pits. A groove may be provided in the second nano-structure. The groove may support definition of a nano-structure representing information in digital form. The groove may be provided in the information surface. The information surface may be provided on one surface of the optical storage medium but could also be provided on two opposite sides of the storage medium.

The geometrical structure may form a helix, but the optical storage medium may also comprise a plurality of concentric geometrical structures. The information may be provided such that it should be read from centre of the medium and outwards, but could also be provided such that it should be read from the outer edge and inwards. The geometrical structure may be provided in structures extending radially on the optical storage medium.

The main substrate may comprise a first and an opposite second surface, at least one of said surfaces may comprise at least a one information surface. In one embodiment both the first and the second surfaces are information surfaces.

The optical storage medium may further comprise at least one additional substrate, each of the at least one additional substrate(s) having a first and a second surface. At least one of the at least one additional substrate(s) may be positioned substantially parallel to a plane defined by the main substrate.

The optical storage medium may, thus, further comprise a first additional substrate having a first and a second surface, the first substrate being substantially parallel to a plane defined by the main substrate and be positioned adjacent to the main substrate. In an embodiment at least a part of the first additional substrate may define a plane transverse to the main substrate such as defining an angle of 5 degrees, such as 10 degrees, such as 15 degrees, such as 20 degrees, such as 25 degrees, such as 30 degrees.

At least one of the first and the second surfaces of the first additional substrate may comprise at least one information surface. In an embodiment both the first and the second surface may be an information surface. The two information surfaces may for example constitute the two layers in a Digital Versatile Disc.

The optical storage medium may further comprise a second additional substrate having a first and a second surface, the second additional substrate being substantially parallel to a plane defined by the main substrate and/or the first substrate. In an embodiment at least a part of the second additional substrate may define a plane transverse to the main substrate and/or the first substrate such as defining an angle of 5 degrees, such as 10 degrees, such as 15 degrees, such as 20 degrees, such as 25 degrees, such as 30 degrees.

At least one of the first and the second surfaces of the second additional substrate may comprise at least one information surface. In an embodiment both the first and the second surfaces may be information surfaces.

The optical storage medium may further comprise a third additional substrate having a first and a second surface, the third additional substrate being substantially parallel to a plane defined by the main substrate and/or the first additional substrate and/or the second additional substrate. In an embodiment at least a part of the third additional substrate may define a plane transverse to the main substrate and/or the first additional substrate and/or the second additional substrate such as defining an angle of 5 degrees, such as 10 degrees, such as 15 degrees, such as 20 degrees, such as 25 degrees, such as 30 degrees.

At least one of the first and the second surfaces of the third additional substrate may comprise at least one information surface. In an embodiment both the first and the second surfaces may be information surfaces.

The optical storage medium may further comprise a fourth additional substrate having a first and a second surface, the fourth additional substrate being substantially parallel to a plane defined by the main substrate and/or the first additional substrate and/or the second additional substrate and/or the third additional substrate. In an embodiment at least a part of the fourth additional substrate may define a plane transverse to the main substrate and/or the first additional substrate and/or the second additional substrate and/or the third additional substrate such as defining an angle of 5 degrees, such as 10 degrees, such as 15 degrees, such as 20 degrees, such as 25 degrees, such as 30 degrees.

At least one of the first and the second surfaces of the fourth additional substrate may comprise at least one information surface. In an embodiment both the first and the second surfaces may be information surfaces.

The optical storage medium may comprise even further additional substrates, such as a fifth, sixth, seventh, eighth, ninth, or a tenth substrate. Said additional substrates may comprise any of the features of the main substrate or the first, second, third or fourth additional substrates.

Any of the first, second, third, fourth, and any further additional substrates may comprise the same materials as the main substrate.

The main substrate may comprise a reflective surface providing the desired reflective properties. The reflective surface may be a surface of the substrate or it may be a reflective layer, such as a metal layer, such as e.g. a tin layer, having the reflective properties. Preferably, such a reflective layer is a conform layer, so as to ensure that any nanostructure formed in the substrate is not blurred. The reflective layer may be provided onto the substrate by sputtering, deposition, evaporation, etc. At least a part of at least one information surface may be covered with a reflective layer. The reflective layer may be reflective for at least electromagnetic waves in a predetermined wavelength range. The layer or the reflective surface of the main substrate may reflect all light emitted to the surface in any predetermined wavelength range but may also reflect 90%, such as 80%, such as 70%, such as 60%, such as 50%, such as 40%, such as 30%. The reflective layer may be thus also be a semi-reflective layer. As an example the semi-reflective layer may either reflect or transmit the majority of light emitted to the layer and thus absorb little of the light. In an embodiment the reflective layer may comprise a metallic material. The reflective layer may be transmitting electromagnetic waves in one wavelength range and be reflecting for electromagnetic waves in another wavelength range.

An information surface of the main substrate may be reflective. An information surface of the first, second, third or fourth additional substrate may also be reflective. In an embodiment a first layer may be reflective while another may be semi-reflective. The reflective layer may be provided between the main substrate and the semi-reflective layer.

The optical storage medium may comprise a multi-layer structure provided on the first surface of the main substrate. In an embodiment a multi-layer structure may be provided on the second surface of the main substrate. Furthermore, both the first and the second surface of the main substrate may be provided with a multi-layer structure.

The multi-layer structure may comprise at least one additional substrate, such as the first additional substrate and/or the additional second, the third additional substrate, and/or the fourth additional substrate and/or any further additional substrates. In one embodiment the order of the substrates in the multi-layer from the main substrate and outwards may be; first, second, third and fourth additional substrate. But the order of the substrates may also be any other, such as second, first, fourth and third additional substrate. In an embodiment with a multi-layer structure on the first and second surface of the main substrate, the order of the first, second, third and fourth additional substrates may be the same on both sides seen from the main substrate and outwards. In another embodiment the order may be different for the two multi-layer structures.

The multi-layer structure may comprise at least one additional substrate at least a part of said at least one additional substrate being connected to the surface on the main substrate on which the multi-layer structure is provided. Only a part of the additional substrate may be connected to the main substrate but the whole substrate may also be connected to the main substrate.

The multi-layer structure may comprise at the first additional substrate, at least a part of said first additional substrate being connected to the surface on the main substrate on which the multi-layer structure is provided. Only a part of the first additional substrate may be connected to the main substrate but the whole substrate may also be connected to the main substrate.

The multi-layer structure may further comprise the second additional substrate, at least a part of said second additional substrate being connected to a surface of the first additional substrate. Only a part of the second additional substrate may be connected to the first additional substrate but the whole substrate may also be connected to the first additional substrate. In an embodiment a part of one side of the second additional substrate may be connected to the first additional substrate while a part of the same side of the second additional substrate is connected to the main substrate.

In an embodiment the multi-layer structure may further comprise the third additional substrate, at least a part of said third additional substrate being connected to a surface of the second additional substrate. Only a part of the third additional substrate may be connected to the second additional substrate but the whole substrate may also be connected to the second additional substrate. In an embodiment a part of one side of the third additional substrate may be connected to the second additional substrate while a part of the same side of the third additional substrate is connected to the first additional substrate, while yet another part of the same side of the third additional substrate is connected to the main substrate.

According to the invention the multi-layer structure may further comprise the fourth additional substrate, at least a part of said fourth additional substrate being connected to a surface of the third additional substrate. Only a part of the fourth additional substrate may be connected to the third additional substrate but the whole substrate may also be connected to the fourth additional substrate. In an embodiment a part of one side of the fourth additional substrate may be connected to the third additional substrate while a part of the same side of the fourth additional substrate is connected to the second additional substrate, while yet another part of the same side of the fourth additional substrate is connected to the first additional substrate, while a further part of the same side of the fourth additional substrate is connected to the main substrate.

The first side and/or the second side of the at least one additional substrates may be provided with a lacquer, an information surface, a reflective layer, a transparent layer, a semi-transparent layer and/or a magnetic layer.

In an embodiment the propagation constant of an electromagnetic wave in the first additional substrate may be lower than the propagation constant of the electromagnetic wave in the second additional substrate, such as 10 percent lower, such as 20 percent lower, such as 30 percent lower, such as 40 percent lower, such as 50 percent lower, such as 60 percent lower, such as 70 percent lower, such as 80 percent lower, such as 100 percent lower or 200 percent lower.

The coefficient of reflection of the first additional substrate may be higher than the coefficient of reflection of the second additional substrate, such as 10 percentage points higher, such as 20 percentage points higher, such as 30 percentage points higher, such as 40 percentage points higher, such as 50 percentage points higher, such as 60 percentage points higher, such as 70 percentage points higher, such as 80 percentage points higher, such as 90 percentage points higher or vice versa.

The following is an example of how to calculate the difference in the focal point when changing from a CD made from polycarbonate to a CD made from a metal substrate.

The first parameter which must be known is the opening angle of the laser beam, which angle is the angle of the beam in relation to the normal to the surface of the CD. In the following, this angle is referred to as αₐᵢᵣ. The angle is measured in relation to the normal of the surface of the CD.

The index of refraction of air nₐᵢᵣ is set to 1. The index of refraction for polycarbonate n_{CD} is 1.55.

$$\begin{matrix}{n}_{air} sin ( {α}_{air} ) = {n}_{CD} sin ( {α}_{CD} ) & 1 \\ {d}_{air} = {d}_{CD} \frac{tan ( {α}_{CD} )}{tan ( {α}_{air} )} & 2\end{matrix}$$

The angle of incidence of the laser beam in a specific standard CD system is 26,744 degrees. If this value is inserted into the formula no. 1, an angle of 16,877 degrees inside the CD is calculated.

By using formula no. 2, it is possible to calculate how much the focal distance on the information surface of the CD is moved if the polycarbonate layer of the CD is replaced by air. If the thickness of the CD is 1,2 mm, dₐᵢᵣ=0,721 mm is calculated.

However, it has been found that also a compensating element is necessary. It is known to place correction or compensating elements in the optical system of a device, such as in a play-back device or an optical microscope. However, to be able to use standard optical systems, it is an advantage to position the compensating means on, adjacent to or in connection with the optical storage medium.

The propagation constant of an electromagnetic wave in the second additional substrate may be lower than the propagation constant of the electromagnetic wave in the third additional substrate, such as 10 percent lower, such as 20 percent lower, such as 30 percent lower, such as 40 percent lower, such as 50 percent lower, such as 60 percent lower, such as 70 percent lower, such as 80 percent lower, such as 100 percent lower or 200 percent lower.

The coefficient of reflection of the second additional substrate may be higher than the coefficient of reflection of the third additional substrate, such as 10 percentage points higher, such as 20 percentage points higher, such as 30 percentage points higher, such as 40 percentage points higher, such as 50 percentage points higher, such as 60 percentage points higher, such as 70 percentage points higher, such as 80 percentage points higher, such as 90 percentage points higher or vice versa.

According to an embodiment of the present invention the propagation rate of an electromagnetic wave in the third additional substrate may be lower than the propagation rate of the electromagnetic wave in the fourth additional substrate, such as 10 percent, lower such as 20 percent lower, such as 30 percent lower, such as 40 percent lower, such as 50 percent lower, such as 60 percent lower, such as 70 percent lower, such as 80 percent lower, such as 100 percent lower or 200 percent lower.

The coefficient of reflection of the third additional substrate may be higher than the coefficient of reflection of the fourth additional substrate, such as 10 percentage points higher, such as 20 percentage points higher, such as 30 percentage points higher, such as 40 percentage points higher, such as 50 percentage points higher, such as 60 percentage points higher, such as 70 percentage points higher, such as 80 percentage points higher, such as 90 percentage points higher.

In an embodiment the first additional substrate and/or second additional substrate and/or the third additional substrate and/or the forth additional substrate may be a semi-transparent material.

Basically, electromagnetic radiation within the spectrum of light, is attenuated in metal as in any other material, i.e. exponentially. The difference between metal and other materials is merely that the process occur over a much shorter distance in metallic materials. Typical values for the thickness of a reflective surface can be estimated from the formula:

$$d = \frac{{λ}_{0}}{4 π {n}_{k}}$$

Wherein d is the layer thickness which attenuates (reflects) the light l/e=0,37, or, in other terms, wherein 63% of the light is transmitted. λ₀ is the wavelength of the laser light in vacuum (in this case, the value is substantially the same as for air), i.e. 780 nm. nₖ is a value which contains both the refractive index and the absorption coefficient for the material. In the case of a sodium lamp, with the wavelength of 5893 Å (589,3 nm) the value is 2,83. It is for this purpose sufficient to provide an estimate for the thickness of the reflective layer. It should be noted that this constant varies strongly in the blue and ultraviolet part of the spectrum. Moreover, the constant is strongly dependent upon the purity of the material, especially for metals like Au, Ag and Al wherein the purity is important. Therefore, in each individual case, a measurement of the reflectivity should be undertaken on the basis of an actual surface.

When the above mentioned values are inserted into the formula, a thickness of 16,5 nm @ 589 nm is calculated. However, to obtain a reflectivity of above e.g. 90%, a thickness of about 200 nm may be needed.

For further details, reference is made to the book “Principles of Optics” written by Born and Wolf.

The first additional substrate and/or the second additional substrate and/or the third additional substrate and/or the fourth additional substrate may be a transparent substrate.

In an embodiment at least one additional substrate of the multi-layer structure may be a peelable foil adhesively bonded to the main substrate and/or a substrate of the multi-layer structure. All the layers of the multi-layer structure may be peelable foils. In an embodiment only a part to the layers of the multi-layer structure are peelable such as the three layers farthest off the main substrate, such as the two layers farthest off the main substrate, such as the layer farthest off the main substrate. In an embodiment every second layer in the multi-layer structure is a peelable foil, thus when a foil is pealed off two layers are removed from the optical storage medium, each of the two layers may comprise an information surface. In the latter embodiment it is possible to peal off two layers constituting a pair of DVD-layers.

The peelable foil may comprise a slip for removal of the foil from the substrate. Furthermore the peelable foil may in a pealed state be non-re-applicable to a surface of the optical storage medium. In the latter embodiment the foil may be used to detect if the optical storage medium has been used. Thus a non-transparent peelable layer may be applied to the surface of the multi-layer structure preventing recognition of the storage medium by an optical detecting means. When the foil is pealed off the storage medium may be read but as the foil is not re-applicable it is possible to see that the storage medium has been used.

In another embodiment the peelable foil comprises an information surface on which a first software is located. Underneath the peelable foil a second information surface may be positioned comprising a second software. The first software may be used to set up a computer so as to enable it to use the second software, thus when the first software has been loaded into the computer the peelable foil may be removed so as to make it possible to read the second software. This may be a way to ensure that a programme is only installed into ONE computer e.g. when information from the first and the second software is needed to run an application. In an other embodiment the pellicle foil may be a programme which needs to be loaded into a computer while the second information surface supports definition of a nano-structure e.g. it may be possible to write/record information on the second information surface.

Furthermore, a supporting means may extend from a plane defined by the main substrate and/or the multi-layer structure. The supporting means may be used to ensure that a desired distance is provided from a laser adapted to read or write on the storage medium so that a desired focus of e.g. a laser beam is obtained. The supporting means may also be adapted to protect an information surface of the optical storage medium as it may elevate the information surface from a surface e.g. a table on which the optical storage medium is placed. Thus dirt or small particles will not damage the information surface.

The supporting means may be formed by a curled edge portion of the main substrate and/or the multi-layer structure substrate. The curled edge portion is preferably formed so as to increase the strength of the substrate. The curled edge portion may be a portion which is bend so that it comprises a curved part and a part which has a cross-section which extends in substantially the same direction. The curl portion may also be shaped such that a cross-section may define at least a part of a helix.

The storage medium may be provided with a centre hole. The hole may be provided in the centre of the main substrate, but could also be provided in another part of the substrate different from the centre of gravity of the optical storage medium.

The curled edge-portion may be formed along an edge of the centre hole. Furthermore the curled edge-portion may be formed along an outer peripheral edge of the main substrate and/or the multi-layer structure. The optical storage medium may comprise a curl portion along both the centre hole and the outer peripheral edge. The curled edge portion of the centre hole and the curled edge portion of the outer peripheral edge may extend in substantially the same direction in relation to the plane defined by the main substrate and/or the multi-layer structure. But the curled edge portions may also extend in opposite directions. The curled edge portions may define an angle in relation to a plane defined by the main substrate and/or the multi-layer structure of 90 degrees, such as 80 degrees, such as 70 degrees, such as 60 degrees, such as 50 degrees, such as 45 degrees, such as 40 degrees, such as 30 degrees, such as 20 degrees, such as 10 degrees.

The curled edge portion may extend from the plane of the optical storage medium, preferably on the information surface side, so as to provide a stopping means protecting the information surface against scratches especially when the optical storage medium is positioned on a table with the information surface downwards.

The optical storage medium may further comprise detachable protecting means for protecting at least a part of the nano-structure. The protecting means may cover a part of the information surface but could also protect the entire information surface. The protecting means may be adapted to engage the centre hole of the substrate. But the protecting means may also be adapted to engage the outer periphery of the optical storage medium. The means for engaging the optical storage medium may be means such as snap-locks which may make it possible to attach the protecting means to the optical storage medium again and again.

The peripheral surface of the protecting means may be shaped as a polygon, such as a quadrangle or a triangle, such as a polygon with five edges, such as a polygon with six edges, such as a polygon with seven edges, such as a polygon with eight edges, such as a polygon with nine edges, such as a polygon with ten edges. The protecting means may be shaped so as to enable positioning of the protecting means side by side with conventional CD-covers. Thus the protecting means may comprise an edge or a side adapted to contain information about the content of the optical storage medium e.g. the name of an artist or the name of a software application provided on an information surface of the substrate.

The reflective layer may comprise a material having a high index of refraction selected from the group consisting of aluminium, silver, gold, platinum, chrome, titanium dioxide and zirconium dioxide and any combination thereof. The reflective material may also comprise alloys made from the aforementioned materials having a high index of refraction.

At least one of the reflective layers may comprise an active reflective layer which may be changed between a non-reflective position and a reflective position. The active reflective layer may be switched between a transparent state and a state where the screen is highly reflective, but the active reflective layer may also be switched to any semi-reflective position so as to reflect 90% of an electromagnetic wave, such as 80%, such as 70% such as 60%, such as 50%, such as 40%, such as 30%, such as 20%, such as 10%.

The active reflective layer comprises liquid crystals adapted to be changed between the two positions. The liquid crystals may be those known from Liquid Crystal Display screens, LCD-screens. An LCD screen or the properties and functionality of such a screen may be provided in the substrate. Thus the entire screen/layer may be reflective. In anther embodiment only a part of the screen is reflective e.g. while another is semi-reflective. The active layer may be adapted to show pictures e.g. any black and white pictures, or colour pictures in the layer/LCD-screen.

Thus the optical storage medium may comprise an active reflection layer and make it possible to access information in some layers in special situations. In an embodiment the optical storage medium may comprise a multi-layer structure comprising one or more layers having the properties of an LCD-screen. When a laser beam is directed to the medium a layer in e.g. the middle of the storage medium may not reflect the laser beam or may provide poor reflection of the laser beam if the LCD-screen like layer is not turned on. When the LCD-screen like layer is turned on a full or nearly full reflection may be provided and thus the information stored in the layer may be read.

The thickness of the main substrate may be selected within the range 100-1400 μm, such as within the range 125-1000 μm, such as within the range 150-800 μm, such as within the range 175-600 μm, such as within the range 200-400 μm, such as 225 μm, such as 250 μm such as 275 μm, such as 300 μm, such as 325 μm, such as 350 μm, such as 375 μm.

The thickness of the at least one additional substrate, such as the first, second, third, fourth, etc. additional substrate, may be selected within the range 0,1-1000 μm, such as within the range 0,5-750 μm, such as within the range 1-500 μm, such as within the range 1,5-250 μm, such as within the range 2-75 μm, such as within the range of 5-10 μm, such as within the range of 100-300 μm.

The total thickness of the optical storage medium including the main substrate and/or one or more additional layers and/or reflective layers may be selected within the range 100-1400 μm, such as within the range 125-1000 μm, such as within the range 150-800 μm, such as within the range 175-600 μm, such as within the range 200-400 μm, such as 225 μm, such as 250 μm such as 275 μm, such as 300 μm, such as 325 μm, such as 350 μm, such as 375 μm.

When designing the optical storage medium the thickness, the refractive index of the layers and the dimensions of the supporting means e.g. the curl portion may be designed such that the focus of the laser beam directed towards the optical storage medium may be acceptable so as to read the information on the optical storage medium

The thickness of the reflective layer may be selected within the range of 0,01-1 μm, such as within the range of 0,02-0,09 μm, such as within the range of 0,03-0,08 μm, such as within the range of 0,04-0,07 μm, such as within the range of 0,05-0,06 μm, such as 0,05 μm. As the reflective layer may comprise an LCD-like layer the thickness may be selected within the range 100-1400 μm, such as within the range 125-1000 μm, such as within the range 150-800 μm, such as within the range 175-600 μm, such as within the range 200-400 μm, such as 225 μm, such as 250 μm such as 275 μm, such as 300 μm, such as 325 μm, such as 350 μm, such as 375 μm.

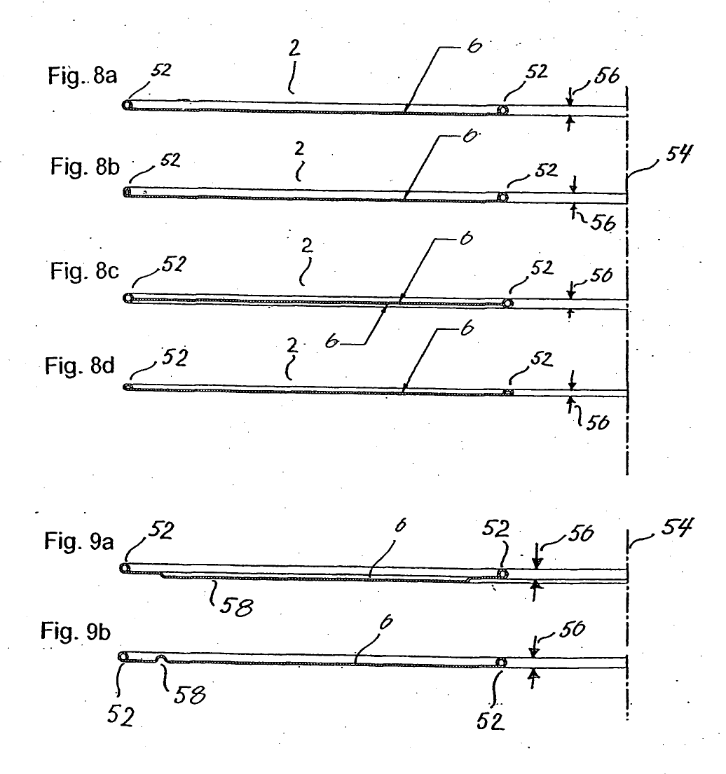

The thickness of the curl portion may be within the range 100-1500 μm, such as within the range 300-1400 μm, such as within the range 500-1350 μm, such as within the range 750-1300 μm, such as within the range 1000-1250 μm, such as substantially 1200 μm. The thickness of the curl portion may be determined as describe in the best mode of carrying out the invention—see description of FIG. 8. The plane defined by the outer surface of the storage medium may be positioned in the opposite direction than the direction in which the curl portion extends. The curl portion may also be used to provide the desired focus of the laser beam.

In an embodiment the main substrate and/or any additional substrates, such as the first, second, third and/or fourth additional substrate may be provided with a colour print layer. The colour print layer may be provided on both sides of any substrate in the optical storage medium. The colour print may comprise a logo, a trade mark, a picture, a stereogram, information about the content of the optical storage medium or any other kind of print. The colour print may be substantially transparent or may be semi-transparent such that a laser beam or any other electromagnetic wave may be able to pass through the colour print.

The colour print layer may be positioned between the main substrate and the first additional substrate. The colour print layer may be positioned between the first additional substrate and the second additional substrate. The colour print may be positioned between the second additional substrate and the third additional substrate. The colour print may be positioned between the third additional substrate and the fourth additional substrate. The colour print layer may be provided on a side of the fourth additional substrate opposite the third additional substrate. The colour prints of the different layer may be provided such that a picture or a desired visual effect is not obtained by the print on only one layer, but only by the colour prints of all or some of the layers. This may provide the effect that a first picture is visible when the peelable layer is provided on the optical storage medium, but when the peelable layer is removed the picture is different or missing. The latter embodiment may make it possible so easy detect if the peelable layer has been removed.

At least one substrate in the multi-layer structure may be coloured, such as blue, green, read or any other colour. The layers may comprise different colours such that when the peelable layer is attached to the optical storage medium one colour is seen (e.g. green), but when the peelable foil, which may be yellow, is removed a third colour, (e.g. blue) is seen.

The colour may be a heat sensitive colour so that the medium e.g. changes colour when being read by a laser beam.

The nanostructure may represent an image and/or text, such as a hologram. The hologram may be used to provide a sign of the authenticity of the optical storage medium and thus show that the medium is not a copy. The different layers of the optical storage medium may comprise one or more holograms, this may provide a special visual effect as a resulting hologram may be obtained.

The optical storage medium may be a Compact Disc, such as an audio CD, such as a super audio CD. The optical storage medium may be a CD-ROM, such as a read-only CD-ROM, such as a recordable CD-ROM, such as a re-writable CD-ROM. The optical storage medium may be a multi-layer medium, such as a DVD, such as a DVD+R/W such as a DVD-R/W such as a DVD-ROM. The optical storage medium may be e.g. a part of a disc-drive medium, such as a floppy disc such as a hard disc. Furthermore the optical storage medium may be a part of minidisc medium or a part of a can. e.g. a lid or a side wall or a bottom part such that the medium may be defined in the can by a weakening line making it possible to press out and separate the optical storage medium. In another embodiment the storage medium may be glued or heat sealed on the can e.g. a side-wall, a bottom part or a top part of a can.

According to a second aspect the invention relates to a method of making an optical storage medium comprising a main substrate, the main substrate comprising a substantially non-transparent material, said method comprising the steps of:
forming an information surface into a surface of the optical storage medium, the information surface supporting definition of a first nano-structure representing information in digital form.

The step of forming the information surface may comprise forming an information surface readable to e.g. a CD-drive thus the information surface may comprise information such as sound, pictures etc. The step of forming the information surface may comprise the step of preparing the optical storage medium for recording or writing information into the information surface such as providing the geometrical structure described above. Thus the result of the process according to the first aspect of the invention may be a recorded or a recordable optical storage medium.

The method may further comprise the step of forming a first nano-structure into the information surface, the first nano-structure representing information in digital form.

The information surface may be provided on the main substrate, e.g. by embossing the nano-structure in a metal surface having a predetermined surface roughness so that the material after embossing may have a high reflectivity. Alternatively, a reflective layer may be provided on top of the embossed structure. It is preferred that such a top layer is a conform layer so as not to blur the embossed nanostructure. The step of forming the information surface into the main substrate may be followed by the step of polishing the surface so as to increase the reflective properties, but the polishing may also be done prior to forming the nano-structure into the main substrate so that the surface has the increased shining properties when the nano-structure is formed.

The method may further comprise the step of providing a first additional substrate on the main substrate. A nano-structure may be formed before and after providing the first additional substrate to the main substrate. When the nano-structure is formed into the main substrate after providing the first additional substrate said nano-structure may be formed into the main substrate by means of e.g. a laser.

The method according to the second aspect of the invention may comprise the step of forming an information surface into the first additional substrate. The information surface may be provided into the surface of the first additional substrate being provided to the main substrate but could also be provided to the surface facing away from the main substrate. The nano-structure of the first additional substrate may be provided prior to providing the first additional substrate to the main substrate. The method may comprise the step of joining the first additional substrate to the main substrate by means of gluing or welding or heat sealing.

The method according to the second aspect of the invention may comprise the step of providing a second additional substrate on the first additional substrate. A nano-structure may be provided in the same ways as for the first additional substrate.

The method may further comprise the step of forming an information surface into the second additional substrate. The information surface may be provided in the same way as it may be done on the first additional substrate.

According to the second aspect of the invention the method may further comprise the step of providing a third additional substrate on the second additional substrate. A nano-structure may be provided in the same ways of for the first additional substrate.

Furthermore a step of forming an information surface into the third additional substrate may be comprised in the method. The information surface may be provided in the same way as it may be done on the first additional substrate.

The method may comprise the step of providing a fourth additional substrate on the third additional substrate. A nano-structure may be provided in the same ways of for the first additional substrate. Further the method may comprise the step of forming an information surface into the fourth additional substrate. The information surface may be provided in the same way as it may be done on the first additional substrate.

The method may comprise the step of covering at least one information surface with a reflective material. The information surfaces may be covered with the reflective layer prior or after providing the substrate on which it is formed to another substrate.

Furthermore, the method may comprise the step of forming a curled edge portion extending from a plane defined by the main substrate one or more additional substrates, such as the first, second, third, or fourth additional substrate. The curled edge portion may be formed by means of a stamping process or a curling process and may be formed prior, in-between or after providing the layers of the optical storage medium.

According to the second aspect of the invention at least a part of the information surface may be formed or provided in the substrate or any additional substrates or in a film layer by a rolling process, a stamping process, a thermal process, an etching process, a cutting process, an electroforming process, an electrolytic process, a magnetic moulding process, a moulding process, an extruding process, an electro-chemical process, and/or a laser writing process, such as a direct laser writing process.

The moulding process may be a UV-moulding process in a hardened mould or by reflowing a plastic material, or embossing in e.g. a not completely hardened mould or an injection moulding process or any other moulding process and/or a compression moulding process or any combination of the processes.

The thermal process may be a laser cutting process or a laser engraving process or any other thermal process. The pressing process may be a hydraulic press process or an excentre press process or any other pressing process.

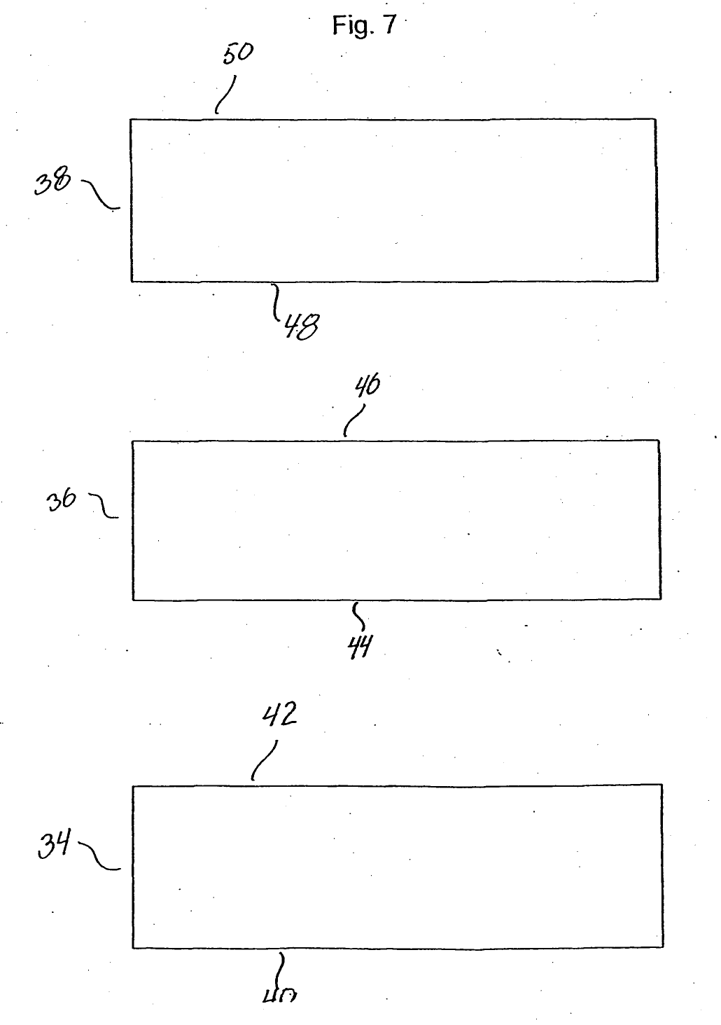

The method may comprise any aspect (e.g. FIG. 7.5 and the pages explaining said figure) of The Compact Disc Handbook (The Computer Music and Digital Audio Series, Vol 5), by Ken C. Pohlmann, Kenneth C. Pohlmann, ISBN: 0895793008

The method may comprise any aspect of (e.g. FIG. 5.2 and FIG. 5.3 and the pages describing said figure) of

DVD Demystified, by Jim Taylor, ISBN: 0071350268

The two books are hereby incorporated by reference.

The second aspect of the invention may comprise any feature or means of the first aspect as described in claims 1-75 and on the previous pages.

Furthermore, according to another aspect of the invention a rolling process, a stamping process, a thermal process, an etching process, a cutting process, a magnetic moulding process, a moulding process, an extruding process, or an electro-chemical process is used for forming an information surface into a substantially non-transparent material, said information surface supporting definition of at least a first nano-structure representing information in digital form. The information surface may comprise a first nano-structure representing information in digital form.

The non-transparent material may a material being non-transparent at least in a predetermined wavelength range. It may be for example be a metallic material.

All the embodiments and aspects described in the present application may be combined in anyway.

### DETAILED DESCRIPTION OF THE INVENTION

An embodiment of the invention will now be described in details with reference to the drawing in which:

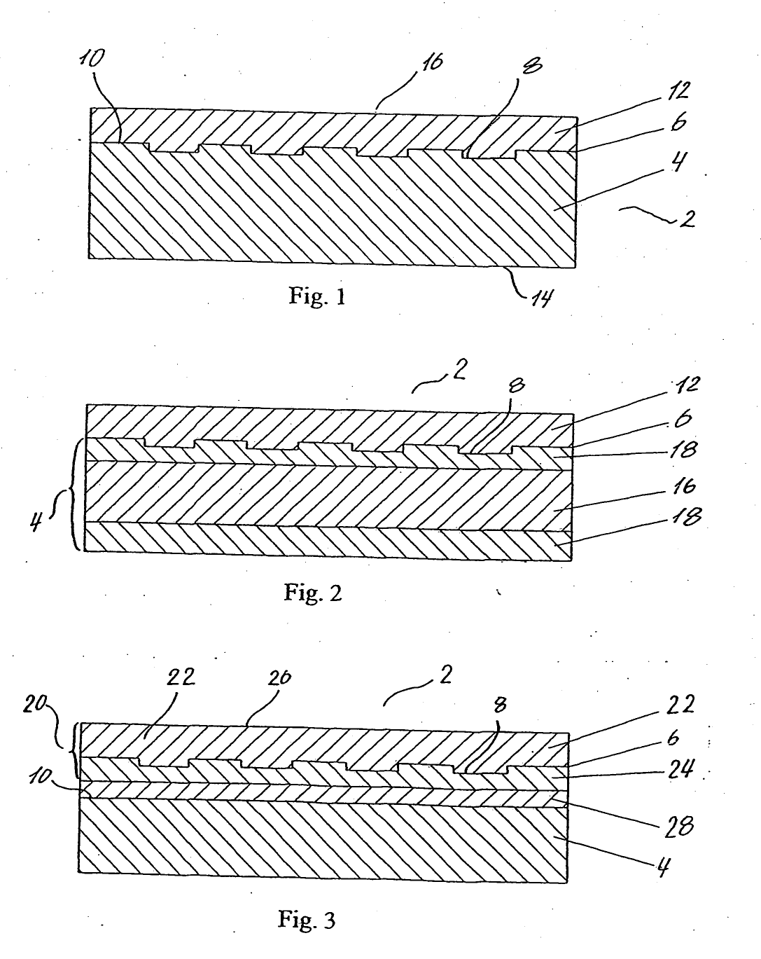

FIGS. 1-6 shows different embodiments of the invention according to the first aspect,

FIG. 7 shows a principle structure of the invention according to the first aspect,

FIGS. 8a-8d shows different embodiments of the curl portion according to the first aspect,

FIGS. 9a-9b shows different embodiments of stiffness providing means,

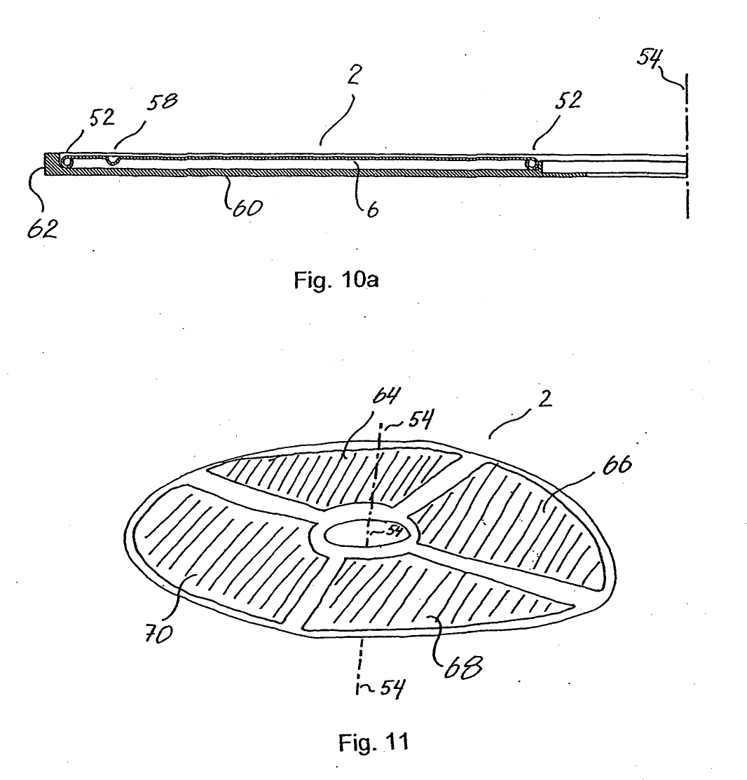

FIG. 10 shows a cover according to the first aspect of the invention,

FIG. 11 shows a substrate comprising a plurality of information surfaces, and

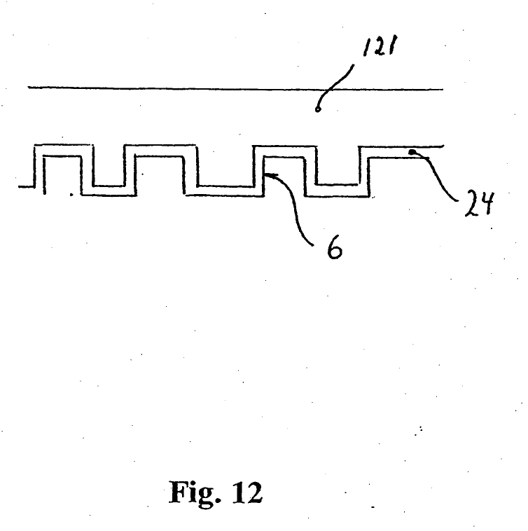

FIG. 12 shows an embodiment of an optical storage medium, wherein a reflective layer follows the nano-structure.

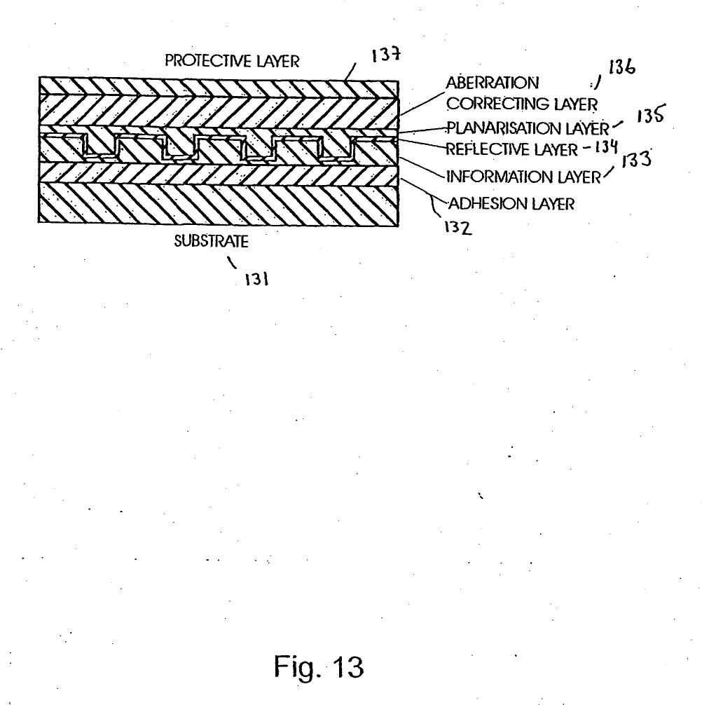

FIG. 13 shows an embodiment of an optical storage medium comprising a compensating layer.

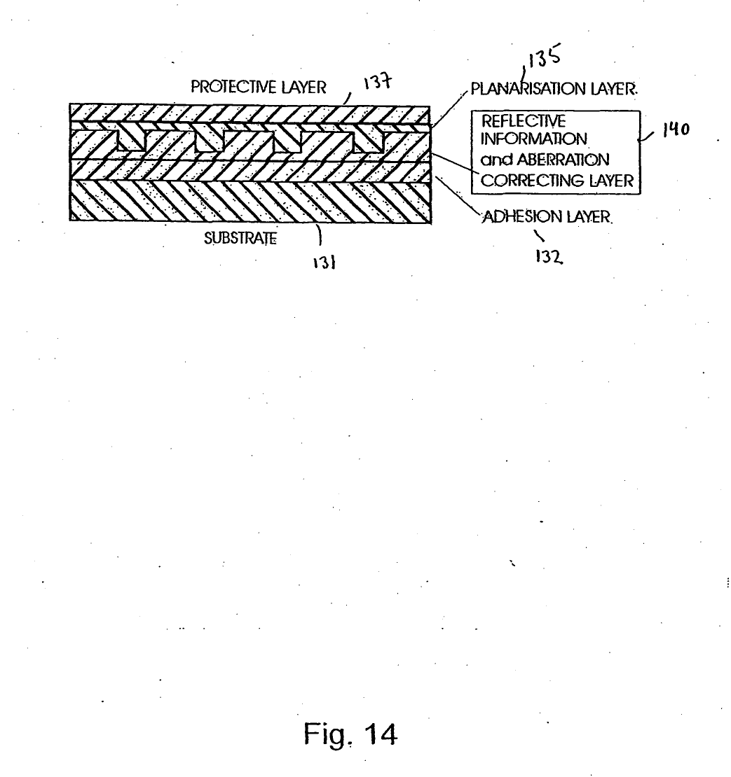

FIG. 14 shows an embodiment of an optical storage medium comprising a combined compensating and reflecting layer.

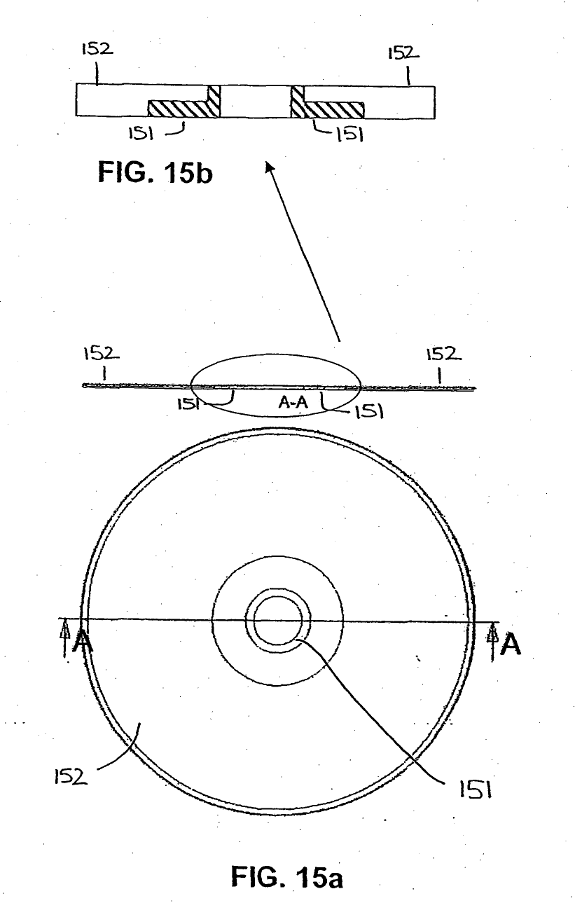

FIG. 15a-b shows an embodiment of an optical storage medium comprising a plastic inner member and a metal substrate.

FIG. 1 shows an optical storage medium 2 comprising a main substrate 4 comprising an information surface 6 on which a nano-structure 8 is provided on a first side 10 of the main substrate 4. The main substrate is made of a non-transparent material, such as aluminium or steel or a non-transparent plastic material. A protecting layer 12 is provided on the nano-structure 8. In an embodiment the nano-structure 8 is provided to the protecting layer 12 prior to attaching the protecting layer 12 to the main substrate 4. A nano-structure may also be provided on a second side 14 of the main substrate (not shown). The second side 14 of the main substrate 4 and the outer surface 16 of the protecting layer 12 are parallel. On the main substrate 4 may be provided a plurality of information surfaces 6, such as one, such as two, such as three, such as four or any other number or information surfaces. The information surfaces 8 may be arranged in zones e.g. in four half-circles each comprising an information surface 8. The information surfaces may also have any other shape such as concentric circles or helixes.

FIG. 2 shows an optical storage medium 2 according to first aspect of the invention. The optical storage medium 2 comprises a main substrate 4 comprising a first layer 16 and a second layer 18 which is provided on two sides of the first layer 16. The first layer 16 is made of steel and the second layer 18 is made of tin. The first layer 16 and the second layer 18 may also comprise any other kind of non-transparent material. Thus the second layer 18 may serve as protection against corrosion of the first layer 16. On one of the second layers 18 is provided an information surface 6 comprising a nano-structure 8. A protecting layer 12 is provided on top of the nano-structure 8 and thus the nano-structure 8 is also provided in the protecting layer 12. The advantage of the second layer 18 of the main substrate may also be to provide a material in which it is easier to emboss the nano-structure 8, while the first layer 16 provides the desired stiffness of the main substrate 4. As described under Fig. the main substrate 4 may be provided with a plurality of information surfaces 6.

FIG. 3 shows an optical storage medium 2 comprising a main substrate 4. The main substrate 4 is made of a non-transparent material such as a metal. On a first side 10 of the main substrate 4 is provided a multi-layer structure 20 comprising a layer 22 comprising an information surface 6 comprising a nano-structure 8. The layer 22 is an additional substrate, such as a first additional substrate but could also be a second, third or fourth additional substrate according to the first aspect of the invention. On the nano-structure 8 is provided a reflective layer 24 enhancing reflection from the nano-structure when an electromagnetic wave e.g. a laser beam is directed towards a upper surface 26 of the layer 22 and transmitted through the layer 22 and reflected by the reflective layer 24. The reflecting layer 24 then reflects the electromagnetic wave and the nano-structure 8 may be detected by a means for detecting electromagnetic waves. The multi-layer structure 20 is laminated or glued to the main substrate 4, by means of a laminating layer 28. The main substrate 4 may comprise a number of information surfaces 6.

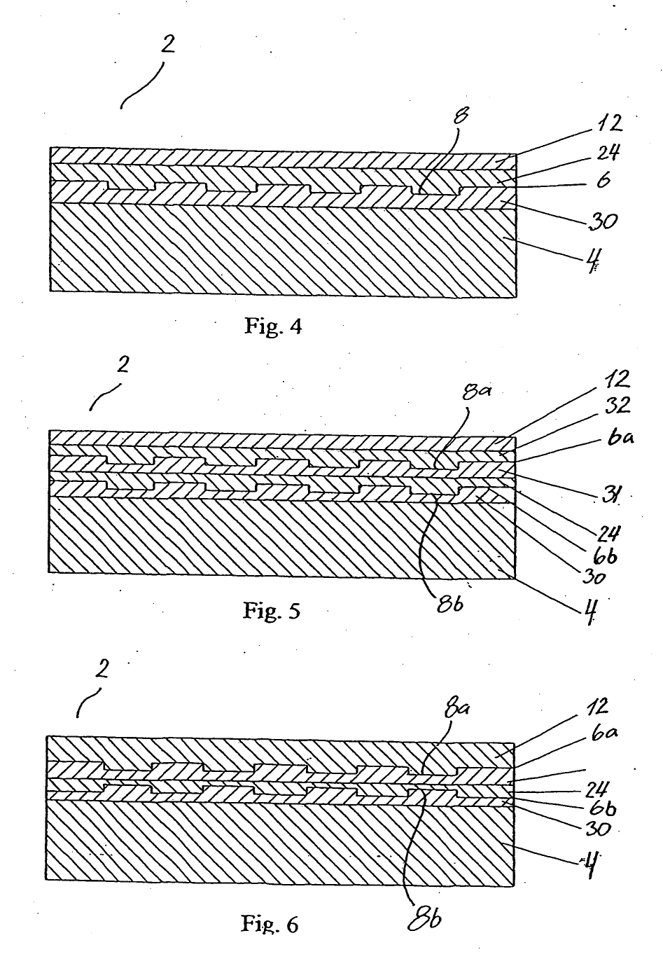

In FIG. 4 is shown a main substrate 4, which is non-transparent e.g. made of a metal. The main substrate 4 may comprise a single layer but could also comprise a plurality of layers as described above. The main substrate 4 is provided with a structure supporting layer 30 which may be a lacquer and may be a first, second, third or fourth layer of the invention according to the first aspect of the invention. On the structure supporting layer 30 is provided an information surface 6 comprising a nano-structure 8. On the nano-structure 8 is provided a reflective layer 24. In some applications the reflective layer 24 will be provided as shown in FIG. 4 while in others the reflective layer 24 will follow the surface of the nano-structure 8 more smoothly as the thickness of the reflective layer 24 will be substantially equal all over the nano-structure 8 as shown in FIG. 12. On the reflecting layer 24 is provided a protecting layer 12. The protective layer may be a lacquer or a polymer film and could be a first, second, third or fourth layer of the invention according to the first aspect of the invention. In FIG. 4. the protecting layer 12 is transparent.

As described in the preceding some embodiments of the invention according to the first aspect of the invention may comprise a plurality of information surfaces 6a and 6b. An example of this is shown in FIG. 5 wherein the optical storage medium 2 comprises two information surfaces 6a and 6b. The optical storage medium 2 comprises a main substrate 4. On the main substrate is provided a structure supporting layer 30, comprising a first information surface 6b, which is covered by a reflective layer 24. The first information surface 6b comprises a first nano-structure 8b. On the reflective layer 24 may be provided a second structure supporting layer 31 comprising a second information surface 6a. The second information surface 6a comprises a second nano-structure 8a on which may be provided a semi-reflective layer 32. The second structure supporting layer 31 may be semi-transparent. On the semi-reflective layer 32 is provided a protecting layer 12.

In FIG. 6 is provided a main substrate 4 on which is provided a structure supporting layer 30. On the structure supporting layer 30 is provided a first information surface 6b comprising a first nano-structure 8b. The first information surface 6b is covered by a reflective layer 24. On the reflective layer is provided a second structure supporting layer 31 comprising the second information surface 6a which comprises a second nano-structure 8a. The second structure supporting layer 31 may be semi-transparent. The second information surface 6a is covered by a protecting layer 12.

FIG. 7. shows a multi-layer structure according to the first aspect of the invention. The multi-layer structure comprises a first additional substrate 34, a second additional substrate 36 and a third additional substrate 38. The first additional substrate 34 comprises a first surface 40 and a second surface 42. The second additional substrate 36 comprises a first surface 44 and a second surface 46. The third additional substrate 38 comprises a first surface 48 and a second surface 50. Any of the first surfaces 40, 44, 48 and any of the second surfaces 42, 46, 50 may comprise one or more information surfaces which may comprise one or more nano-structures. As an example one of the surfaces may comprise four information surfaces grouped in four zones dividing the surface into four half circles. Any other number of information surfaces may be provided on a surface. On any information surface may be provided a reflective layer or the substrate may be made of a reflective layer which may be reflective with or without being polished.

FIGS. 8a-8d, 9a-9b and 10 shows different embodiments of curl portions 52 of the optical storage medium 2 having a centre axis 54 and an information surface 6. The thickness 56 of the curl portion 52 is determined as shown in the figure. FIGS. 9a and 9b further shows stiffness supporting means 58. FIG. 10 further shows a cover 60 comprising a surface 62 on which information about the content of the optical storage medium 2 is provided. The cover 60 may be quadrangular.

FIG. 11 shows a optical storage medium 2 having a centre axis 54 and comprising a plurality of information surfaces i.e. a first information surface 64, a second information surface 66, a third information surface 68 and a fourth information surface 70. Any other number of information surfaces may be provided on a surface of the optical storage medium and the information surfaces may have any shape.

In FIG. 12, the nano-structure of an information surface 6 is covered with a reflective layer 24. The reflective layer is covered with a layer of protective lacquer 121 or with similar means for protecting the surface of the reflective layer. The reflective layer is provided so that both surfaces thereof, i.e. the surface facing the information surface and the surface facing the protective lacquer narrowly follows the contour of the information surface. Accordingly, the two surfaces of a reflective material both forms contours representing the same information.

FIG. 13 shows a cross-section of one embodiment of an optical storage medium according to the invention. On a main substrate 131, a buffer or adhesion layer 132 is provided for obtaining a good connection between main substrate 131 and film layer 133. The information structure is embossed in the film layer 133 to form an information surface, such as for example a nano-structure embossed in the film layer 133 to represent information in digital form. The information surface is coated by a reflective layer 134, such as a metallic layer, preferably such as an aluminium layer. The reflective layer 134 is preferably evaporated on to the information surface, and as shown in FIG. 13, the reflective layer 134 is sufficiently thin so as to allow for a conform coverage of the information surface. A planarising layer 135 is provided on top of the reflective layer for planarising of the surface.

On the planarising layer, a compensating layer 136 is provided for compensating for any aberrations not otherwise corrected for in the system, such as aberrations inferred by the provision of an optical storage medium having a thickness other than the thickness expected by the optical system, or comprises a material having different optical properties than the optical material properties expected by the optical system.

The whole structure is covered by a protective layer 137 protecting the surface of the structure.

FIG. 14 shows a cross-section of another embodiment of an optical storage medium according to the invention. On a main substrate 131, a buffer or adhesion layer is provided for obtaining a good connection between main substrate 131 and film layer 140. The buffer or adhesion layer is an optional layer, which may be omitted provided that a good connection can be provided either directly between the main substrate and the film layer or by giving the main substrate a surface treatment, such as a Corona treatment or a chemical surface treatment.

The information surface is provided to the film layer 140. The film layer 140 is a reflective layer so that no additional reflective layer is needed. Furthermore, the film layer 140 comprises the compensating layer 136, for example in the form of an interference filter, for compensating for any aberrations in the system caused for example by the optical storage medium having a thickness different from a predetermined thickness determined by the optical system, or comprises a material having a different optical transfer function than the optical transfer function determined by the optical system.

A planarising layer is provided on the film layer 140 comprising the nano-structure, the reflective layer and the compensating layer. Finally, a protective layer is provided on top of the planarising layer. It is envisaged that in an alternative embodiment the planarising layer may also form the protective layer.

FIG. 15a shows another embodiment of the invention wherein the optical storage medium comprises two parts 151, 152, each part being of a different material. FIG. 15a shows a sketch of an optical storage medium comprising a plastic inner member 151 and a metal substrate 152. An enlarged schematic view of the circled inner part of the optical storage medium is shown in FIG. 15b. It may be advantageous to use a plastic inner member 151 since a high precision is easily obtainable by plastic manufacturing, such as e.g. die casting, whereas a corresponding high precision when manufacturing metal is more demanding to obtain.

1. An optical storage medium comprising:
a main substrate,
an information surface being associated with the main substrate, and
at least one compensating layer.

2. An optical storage medium according to claim 1, wherein the at least one compensating layer is positioned between the information surface and an outer surface of the medium.

3. An optical storage medium according to claim 1, wherein the at least one compensating layer changes a phase and/or amplitude of a propagating electromagnetic wave front according to a first optical transfer function so as to adapt the optical storage medium to be read or recorded by a detector/emitter being pre-set to read or record information at an information surface through a medium changing the phase and/or amplitude of a propagating wave front according to a predetermined optical transfer function,
wherein the first optical transfer function is different from the predetermined optical transfer function.

4. An optical storage medium according to claim 2, wherein the compensating layer is positioned between the outer surface and the information surface for compensating for the at least first distance being different from a predetermined distance by optically reducing a spot size of a light beam incident on the information surface.

5. An optical storage medium according to claim 2, wherein the compensating layer is positioned between the outer surface and the information surface for compensating for aberrations caused by the at least first distance being different form a predetermined distance.

6. (canceled)

7. An optical storage medium according to claim 1, further comprising at least one additional substrate, each additional substrate having a first and a second surface.

8. An optical storage medium according to claim 1, wherein at least one of the at least one additional substrate(s) are substantially parallel to a plane defined by the main substrate.

9 and 10. (canceled)

11. An optical storage medium according to claim 1, wherein the information surface comprises information in digital form.

12. An optical storage medium according to claim 1 wherein the information surface supports definition of at least a first nano-structure representing information in digital form.

13. An optical storage medium according to claim 4, wherein the predetermined distance is 1,2 mm.

14. An optical storage medium according to claim 4, wherein the predetermined distance is 0,6 mm.

15-98. (canceled)

99. Use of an optical storage medium having a thickness of less than 1,1 mm in a standard optical playback device.

100. A method of making an optical storage medium comprising a main substrate, the main substrate comprising a substantially non-transparent material, said method comprising the steps of:
forming an information surface into a surface of the optical storage medium, the information surface supporting definition of a first nano-structure representing information in digital form,
providing at least one compensating layer being associated with the information surface.

101. A method according to claim 100, further comprising the step of forming a first nano-structure into the information surface, the first nano-structure representing information in digital form.

102. A method according to claim 100, wherein the information surface is provided on the main substrate.

103. A method according to claim 100, further comprising the step of providing at least one additional substrate on the main substrate.

104. A method according to claim 100, further comprising the step of forming an information surface into at least one additional substrate.

105. A method according to claim 100, further comprising the step of covering at least one information surface with a reflective material.

106. A method according to claim 100, further comprising the step of forming a curled edge portion extending from a plane defined by the main substrate and/or the at least one additional substrate.

107. A method according to claim 100, wherein at least a part of the information surface is formed by at least one of a rolling process, a stamping process, a thermal process, an etching process, a cutting process, an electroforming process, an electrolytic process, a magnetic moulding, moulding, extruding or an electrochemical process.

108-109. (canceled)
